(19) United States
(12) Patent Application Publication
(10) Pub. No.: US 2007/0194715 A1
(43) Pub. Date: Aug. 23, 2007

(54) Film type filter and plasma display apparatus comprising the same

(76) Inventors: Jun-Kyu Cha, Suwon-si (KR); Jae-Woo Bae, Suwon-si (KR); Dong-Gun Moon, Suwon-si (KR); Sang-Yeol Hur, Suwon-si (KR); Chan-Wook An, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/707,024

(22) Filed: Feb. 16, 2007

(30) Foreign Application Priority Data
Feb. 17, 2006 (KR) 10-2006-0015612

(51) Int. Cl. H01J 17/49

(52) U.S. Cl. 313/582; 313/587; 313/586

(57) ABSTRACT

A plasma display apparatus, including a plasma display panel, aligning marks on the plasma display panel, and a film filter attached to a front surface of the plasma display panel, where portions of the film filter corresponding to the aligning marks are exposed so that the aligning marks may be readily recognized.

### BACKGROUND OF THE INVENTION

1. Field of the Invention

The present invention relates to a film filter and a plasma display apparatus including the same.

2. Description of the Related Art

Plasma displays are flat panel displays that may display images using a discharge effect. Panel plasma displays are considered to be the next generation of display devices because of their excellent characteristics, e.g., high brightness, high contrast, clear latent images, wide viewing angles, slim structure, large screen size, etc.

Plasma displays may usually include a filter in front of the plasma display panel to improve the optical characteristics of the plasma display panel and to shield the environment from electromagnetic waves produced by the plasma display panel from being emitted by the plasma display apparatus. The filter may usually be, e.g., a glass filter that frequently is heavy and expensive. To address the disadvantages of glass filters, film type filters may be directly attached on a front surface of plasma display panels

However, proper alignment of a film type filter is frequently difficult due to the number of components and the display geometry. As a result, new technologies are needed to incorporate thin film technologies into plasma displays.

### SUMMARY OF THE INVENTION

The present invention is therefore directed to a display apparatus having a film type filter that substantially overcomes one or more of the problems due to the limitations and disadvantages of the related art.

It is therefore a feature of an embodiment of the present invention to provide a film type filter that allows easy aligning between a plasma display panel and a chassis, and a plasma display apparatus including the film type filter.

At least one of the above and other features and embodiments of the present invention may be realized by providing a plasma display apparatus that may include a plasma display panel, aligning marks that may be on the plasma display panel, and a film filter that may be attached to a front surface of the plasma display panel, where portions of the film filter corresponding to the aligning marks may be exposed so that the aligning marks may be readily recognized.

Apertures may be formed in the film filter corresponding to the aligning marks. Cut out portions in the film filter may correspond to the aligning marks.

Exposed portions of the film filter may correspond to edges of the film filter. The exposed portions may correspond to the aligning marks of the plasma display panel, and the exposed portions may be disposed symmetrically in the film filter with respect to a center of the film filter. The film filter may be composed of a base film and an antiglare layer on the base film. The film filter may include an electromagnetic wave shielding layer on the base film. The electromagnetic wave shielding layer may include a grounding unit formed on an edge of the base film, and a shielding unit may be electrically connected to the grounding unit and may have a mesh pattern. The exposed portions may be in a lateral portion of the film filter corresponding to the grounding unit of the electromagnetic wave shielding layer.

The electromagnetic wave shielding layer may include a stack of at least one metal layer or metal oxide layer. The metal layer may be composed of at least one of palladium, copper, platinum, rhodium, aluminum, iron, cobalt, nickel, zinc, ruthenium, tin, tungsten, iridium, lead, or silver. The metal oxide layer may be composed of at least one of tin oxide, indium oxide, antimony oxide, zinc oxide, zirconium oxide, titanium oxide, magnesium oxide, silicon oxide, aluminum oxide, metal alkoxide, indium tin oxide, or antimony tin oxide. The base film may be composed from at least one of polyethersulphone (PES), polyacrylate (PAR), polymethacrylate (PM), polyetherimide (PEI), polyethylene naphthalate (PEN), polyethylene terephthalate (PET), polyphenylene sulfide (PPS), polyallylate, polyimide, polycarbonate (PC), cellulose tri-acetate (TAC), cellulose acetate propionate (CAP), or other cellulosics.

At least one of the above and other features and embodiments of the present invention may be realized by providing a plasma apparatus that may include a display panel, aligning marks on the display panel and a base film attached to a front surface of the display panel, where portions of the film filter corresponding to the aligning marks may be exposed so that the aligning marks may be readily recognized.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial cutaway perspective view of a film type filter for a plasma display apparatus according to an embodiment of the present invention;

FIG. 2 illustrates an exploded perspective view showing the film type filter of FIG. 1 being attached to a plasma display panel;

FIG. 3 illustrates a front view of a plasma display panel attached to the film type filter of FIG. 1;

FIG. 4 illustrates a front view of a plasma display panel attached to a film type filter according to another embodiment of the present invention; and

FIG. 5 illustrates a cross-sectional view of a plasma display apparatus that includes the film type filter of FIG. 1 according to an embodiment of the present invention.

### DETAILED DESCRIPTION OF THE INVENTION

Korean Patent Application No. 10-2006-0015612, filed on Feb. 17, 2006, in the Korean Intellectual Property Office, and entitled: “Film Type Filter and Plasma Display Apparatus Comprising the Same,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In plasma display panels that employ a film type filter, the film type filter may be fixed on the front surface of the plasma display panel using, e.g., an acrylic adhesive. The plasma display panel and a chassis may be coupled together after the film type filter is attached to the front surface of the plasma display panel. Afterward, circuit units may be mounted on a rear surface of the chassis. In this process of mounting the plasma display panel to the chassis, the plasma display panel and the chassis may preferably be correctly aligned. The alignment may be achieved by forming an aligning mark that may be recognized by a CCD camera on a front surface of the plasma display panel, and then using the CCD camera and the aligning mark to align the plasma display panel with the chassis.

However, when a film type filter is attached to the surface of a plasma display panel, the film type filter may cover the aligning mark formed on the plasma display panel. In particular, since an opaque metal grounding unit for shielding electromagnetic waves being emitted out of the plasma display apparatus may be disposed on an edge of the film type filter, recognition of the aligning mark by the CCD camera may become more difficult. Accordingly, the coupling of the plasma display panel and the chassis may be hindered.

The film type filter according to the present invention and the plasma display apparatus having the film type filter may provide the following advantages.

First, since the aligning marks of the plasma display panel may be exposed, the film type filter may not hinder the aligning of the plasma display panel with the chassis, since a CCD camera may readily recognize the aligning marks. Accordingly, the plasma display panel and the chassis may be readily aligned.

Second, the exposed portions of the film type filter may be readily formed by, e.g., a perforating process, a cut-out process, etc., thereby increasing workability.

The present invention will now be described more fully with reference to the accompanying drawings in which exemplary embodiments of the invention are shown.

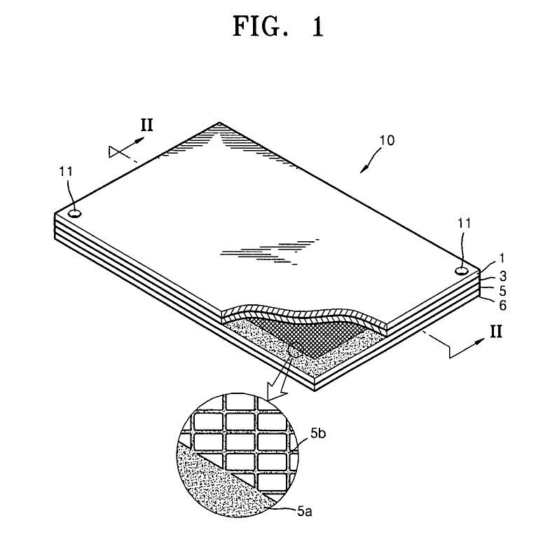

FIG. 1 illustrates a partial cutaway perspective view of a film type filter 10 for a plasma display apparatus according to an embodiment of the present invention. In FIG. 1, the film type filter 10 may include, e.g., a base film 3, an antiglare layer 1, an electromagnetic wave shielding layer 5, and an adhesive layer 6.

The base film 3 may be formed of at least one of, e.g., polyethersulphone (PES), polyacrylate (PAR), polymethacrylate (PM), polyetherimide (PEI), polyethylene naphthalate (PEN), polyethylene terephthalate (PET), polyphenylene sulfide (PPS), polyallylate, polyimide, polycarbonate (PC), cellulose tri-acetate (TAC), cellulose acetate propionate (CAP), other cellulosics, etc. Blends, alloys and/or copolymers of these materials may also be used. Preferably, the base film 3 may be formed from at least one of, e.g., PC, PET, TAC, or PEN. Besides the polymeric materials mentioned above, the base film 3 may also include, e.g., plasticizers, fillers, antioxidants, ultraviolet inhibitors, pigments, etc.

The antiglare layer 1 may be formed on the base film 3. The antiglare layer 1 may scatter external light that may be incident on a surface thereof, and the antiglare layer 1 may prevent reflection of images of objects located near the plasma display apparatus, by the film type filter 10. An antiglare layer may not be applied to a related art reinforced glass filter because, if applied, image clarity may be diminished due to a gap between a front substrate and the reinforced glass filter. However, in the present invention, since the film type filter 10 may be directly attached to the plasma display panel, the image clarity is not diminished, and thus the advantages of the antiglare layer 1 can be realized. The antiglare layer 1 may be formed by, e.g., forming fine corrugations on the base film 3.

The antiglare layer 1 may be formed using, e.g., a dip coating method, an air knife method, a curtain coating method, a roller coating method, a wire bar coating method, a gravure coating method, etc.

The antiglare layer 1 may include a hard coating material. The display apparatus to which the film type filter may be applied may receive various types of external forces during usage. As a result, there may be a high probability of scratches or other imperfections being formed. Including a hard coating material in the antiglare layer 1 may thus prevent the antiglare layer 1 from being scratched.

An anti-reflective layer (not shown) may also be disposed on the antiglare layer 1. Alternately, the anti-reflective layer may be disposed instead of the antiglare layer 1.

The electromagnetic wave shielding layer 5 may be disposed on the other side of the base film 3. The electromagnetic wave shielding layer 5 may shield harmful electromagnetic waves generated by the plasma display. Referring to the insert in FIG. 1, the electromagnetic wave shielding layer 5 may include a grounding unit 5a formed on an edge of the base film 3, and a shielding unit 5b may be electrically connected to the grounding unit 5a. The shielding unit 5b may be formed in, e.g., a mesh pattern. The mesh pattern of the shielding unit 5b, shown in FIG. 1, may have a rectangular shape, but the present invention is not limited thereto, and the pattern of the shielding unit 5b may be formed using various shapes, e.g., a slant line shape, a circle shape, an oval shape, a parallelepiped shape, a non-distinct shape, etc. Also, the electromagnetic wave shielding layer 5 may be formed of various metals having high electrical conductivity, e.g., copper, aluminum, etc.

The electromagnetic wave shielding layer 5 may also be formed by stacking at least one metal layer or metal oxide layer on the base film 3. In this case, the metal layer may be formed of at least one of, e.g., palladium, copper, platinum, rhodium, aluminum, iron, cobalt, nickel, zinc, ruthenium, tin, tungsten, iridium, lead, silver, etc. Composites of these metals may also be used. Also, the metal oxide layer may be formed of, e.g., tin oxide, indium oxide, antimony oxide, zinc oxide, zirconium oxide, titanium oxide, magnesium oxide, silicon oxide, aluminum oxide, metal alkoxide, indium tin oxide, antimony tin oxide (ATO), etc.

The film type filter 10 may further include an adhesive layer 6 disposed on the electromagnetic wave shielding layer 5. The adhesive layer 6 may be used to attach the film type filter 10 to the plasma display panel. However, the adhesive layer 6 may be coated on a front surface of the plasma display panel instead of being included in the film type filter 10.

Referring to FIG. 1, apertures 11 may be formed in corner portions of the film type filter 10. The apertures 11 may correspond to aligning marks formed on the plasma display panel. The apertures 11 may preferably be formed on a location of the plasma display panel corresponding to the grounding unit 5a of the electromagnetic wave shielding layer 5. The apertures 11 illustrated in FIG. 1 have a circular shape. However, other shaped apertures may be used, e.g., squares, rectangles, ovals, etc. The apertures 11 may be formed by, e.g., perforating the film type filter 10 after the film type filter 10 is formed.

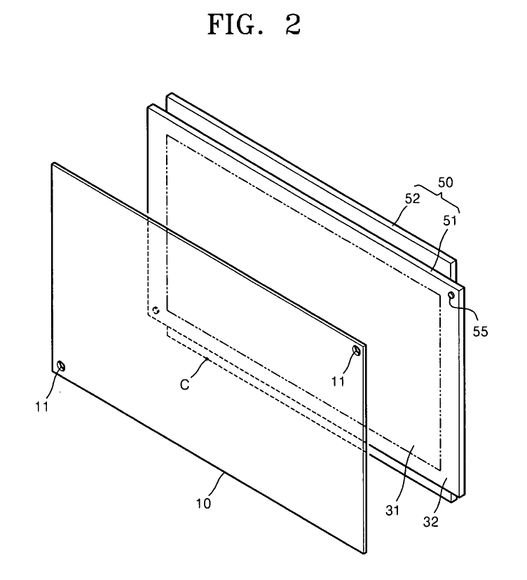

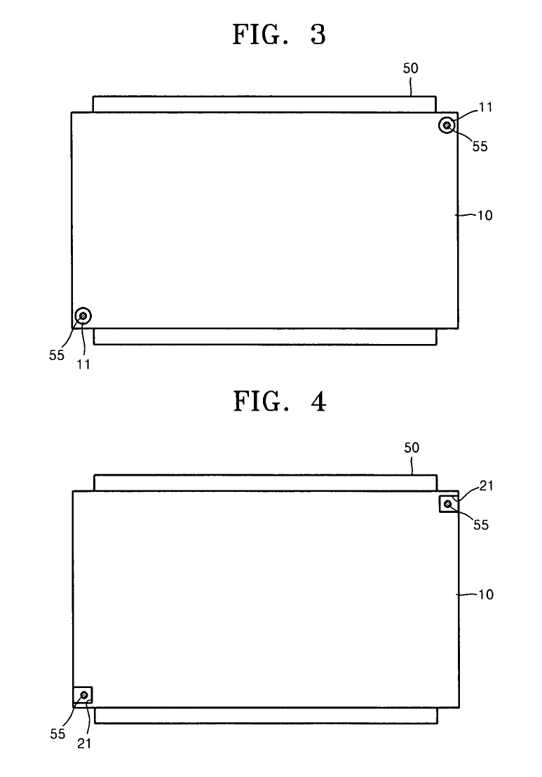

FIG. 2 illustrates an exploded perspective view of the film type filter 10 of FIG. 1 being attached to a plasma display panel 50. FIG. 3 illustrates a front view of a plasma display panel 50 when the film type filter 10 of FIG. 1 is attached. The plasma display panel 50 may have a structure in which a front panel 51 and a rear panel 52 are coupled, and may include a display region 31, where images are displayed. There may be an overlap C between the front panel 51 and the rear panel 52. A non-display region 32 may surround the display region 31. Aligning marks 55 for aligning a chassis and the plasma display panel 50 may be formed in the non-display region 32 of the plasma display panel 50. Since the aligning marks 55 may be disposed, e.g., in opposite portions equidistant from the center of the plasma display panel 50, the apertures 11 may also be disposed in opposite corners equidistant from the center of the film type filter 10. The apertures 11 may be formed to be larger than the aligning marks 55. Also, the apertures 11 and the aligning marks 55 need not be respectively located at the corners of the film type filter 10 and the plasma display panel 50. The apertures 11 and the aligning marks 55 may be located near the edges midway between the corners of the respective film type filter 10 and the plasma display panel 50.

Since the aligning marks 55 may be exposed to the outside environment by the apertures 11, a camera, e.g., a CCD camera, may readily recognize the aligning marks 55. Therefore, the film type filter 10 may not hinder the aligning of the plasma display panel 50 with the chassis (not shown), since the CCD camera may readily recognize the aligning marks 55. The present invention is not restricted to using a CCD camera, and other types of cameras may be used.

FIG. 4 illustrates a front view of a plasma display panel 50 with an attached film type filter 10 according to another embodiment of the present invention. Cut-out portions 21 formed in a square shape may be formed on edges of the film type filter 10 corresponding to locations of the aligning marks 55 of the plasma display panel 50. Since the aligning marks 55 may be exposed to the outside environment by the cut-out portions 21, the CCD camera may readily recognize the aligning marks 55. Accordingly, the CCD camera may readily recognize the aligning marks 55, and thus, the aligning of the plasma display panel 50 with respect to the chassis (not shown) may be readily achieved. The cut-out portions 21 may be formed using, e.g., a cutting process, after the film type filter 20 is formed.

Also, since the aligning marks 55 may be disposed, e.g., in opposite portions equidistant from the center of the plasma display panel 50, the cut-out portions 21 may also be disposed in opposite corners equidistant from the center of the film type filter 10. The cut-out portions 21 may be formed to be larger than the aligning marks 55. The cut-out portions 21 and the aligning marks 55 need not be respectively located at the corners of the film type filter 10 and the plasma display panel 50. The cut-out portions 21 and the aligning marks 55 may be located near the edges midway between the corners of the respective film type filter 10 and the plasma display panel 50.

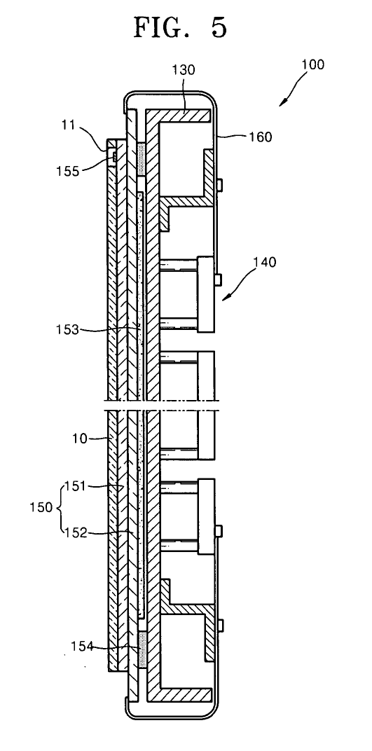

FIG. 5 illustrates a cross-sectional view of a plasma display apparatus 100 that includes the film type filter 10 of FIG. 1 according to an embodiment of the present invention. For explaining the structure of the plasma display apparatus 100, like reference numerals are used to denote like elements of previous embodiments.

The plasma display apparatus 100 may include a film type filter 10, a plasma display panel 150, a chassis 130, a thermal conductive member 153, strips of double-sided tape 154, and circuit units 140.

The plasma display panel 150 may display images using gas discharge. The plasma display panel 150 may include a front panel 151 coupled to a rear panel 152 coupled to each other. Aligning marks 155 for aligning the plasma display panel 150 with the chassis 130 may be formed on a front surface of the front panel 151.

The film type filter 10 may be attached to the front surface of the plasma display panel 150 using an adhesive layer 6 (shown on FIG. 1). Apertures 11 may be formed in the film type filter 10 at locations corresponding to the aligning marks 155, to expose the aligning marks 155.

The plasma display apparatus 100 according to the present invention is not limited to the structures including the film type filter 10, and various other film type filters may be applied.

The chassis 130 may be disposed on a rear side of the plasma display panel 150 to structurally support the plasma display panel 150. The chassis 130 may be formed of, e.g., a plastic or a metal having high strength, preferably aluminum, iron etc.

The thermal conductive member 153 may be disposed between the plasma display panel 150 and the chassis 130. Also, multiple strips of double-sided tape 154 may be disposed along an outer portion of the surface of the thermal conductive member 153 to fix the plasma display panel 150 to the chassis 130.

The circuit units 140 may be disposed on a rear surface of the chassis 130.

The circuit units 140 may include circuits for driving the plasma display panel 150.

The circuit units 140 may transmit electrical signals to the plasma display panel 150 through signal transfer members 160. The signal transfer member may be, e.g., a flexible printed cable (FPC), a tape carrier package (TCP), a chip on film (COF), etc. TCPs, acting as the signal transfer members 160, may be disposed on upper and lower ends of the chassis 130.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display apparatus, comprising:
a plasma display panel;
aligning marks on the plasma display panel; and
a film filter attached to a front surface of the plasma display panel, wherein portions of the film filter corresponding to the aligning marks are exposed so that the aligning marks are readily recognized.

2. The plasma display apparatus as claimed in claim 1, wherein apertures in the film filter correspond to the aligning marks.

3. The plasma display apparatus as claimed in claim 1, wherein cut-out portions in the film filter correspond to the aligning marks.

4. The plasma display apparatus as claimed in claim 1, wherein the exposed portions of the film filter correspond to edges of the film filter.

5. The plasma display apparatus as claimed in claim 1, wherein the exposed portions correspond to the aligning marks of the plasma display panel, and the exposed portions are disposed symmetrically in the film filter with respect to a center of the film filter.

6. The plasma display apparatus as claimed in claim 1, wherein the film filter comprises a base film and an antiglare layer on the base film.

7. The plasma display apparatus as claimed in claim 6, wherein the film filter further comprises an electromagnetic wave shielding layer disposed on the base film.

8. The plasma display apparatus as claimed in claim 7, wherein the electromagnetic wave shielding layer includes a grounding unit formed on an edge of the base film, and a shielding unit is electrically connected to the grounding unit.

9. The plasma display apparatus as claimed in claim 8, wherein the shielding unit has a mesh pattern.

10. The plasma display apparatus as claimed in claim 8, wherein the exposed portions are in a lateral portion of the film filter corresponding to the grounding unit.

11. The plasma display apparatus as claimed in claim 7, wherein the electromagnetic wave shielding layer includes at least one conductive layer.

12. The plasma display apparatus as claimed in claim 11, wherein the conductive layer is composed of at least one of palladium, copper, platinum, rhodium, aluminum, iron, cobalt, nickel, zinc, ruthenium, tin, tungsten, iridium, lead, or silver.

13. The plasma display apparatus as claimed in claim 11, wherein the conductive layer is composed of at least one of tin oxide, indium oxide, antimony oxide, zinc oxide, zirconium oxide, titanium oxide, magnesium oxide, silicon oxide, aluminum oxide, metal alkoxide, indium tin oxide, or antimony tin oxide.

14. The plasma display apparatus as claimed in claim 6, wherein the base film is composed from at least one of polyethersulphone (PES), polyacrylate (PAR), polymethacrylate (PM), polyetherimide (PEI), polyethylene naphthalate (PEN), polyethylene terephthalate (PET), polyphenylene sulfide (PPS), polyallylate, polyimide, polycarbonate (PC), cellulose tri-acetate (TAC), cellulose acetate propionate (CAP), or other cellulosics.

15. The plasma display apparatus as claimed in claim 6, wherein the base film is composed from at least one of polycarbonate (PC), polyethylene terephthalate (PET), cellulose tri-acetate (TAC), or polyethylene naphthalate (PEN).

16. A display apparatus, comprising:
a display panel;
aligning marks on the display panel; and
a base film attached to a front surface of the display panel, wherein portions of the base film corresponding to the aligning marks are exposed so that the aligning marks are readily recognized.

17. The display apparatus as claimed in claim 16, wherein an antiglare layer is on the base film.

18. The display apparatus as claimed in claim 16, wherein an electromagnetic wave shielding layer is on the base film.

19. The display apparatus as claimed in claim 16, wherein the base film is composed from at least one of polyethersulphone (PES), polyacrylate (PAR), polymethacrylate (PM), polyetherimide (PEI), polyethylene naphthalate (PEN), polyethylene terephthalate (PET), polyphenylene sulfide (PPS), polyallylate, polyimide, polycarbonate (PC), cellulose tri-acetate (TAC), cellulose acetate propionate (CAP), or other cellulosics.

20. The display apparatus as claimed in claim 16, wherein the display apparatus is a plasma display apparatus.
